(19) United States
(12) Patent Application Publication
(10) Pub. No.: US 2019/0190420 A1
(43) Pub. Date: Jun. 20, 2019

(54) INSTALLATION AND METHOD FOR GENERATING A THREE-PHASE AC VOLTAGE TO BE FED INTO A POWER SUPPLY SYSTEM

(71) Applicant: SIEMENS AKTIENGESELLSCHAFT, Munich (DE)

(72) Inventors: Christoph LEHMANN, Neukirchen-Vluyn (DE); Uwe JURETZEK, Erlangen (DE)

(73) Assignee: Siemens Aktiengesellschaft, Munich (DE)

(21) Appl. No.: 16/302,311

(22) PCT Filed: Apr. 20, 2017
(86) PCT No.: PCT/EP2017/059429

§ 371 Date: Nov. 16, 2018

(30) Foreign Application Priority Data
May 23, 2016 (EP) 16170763.3

(51) Int. Cl. H02P 9/00; H02P 9/38; H02J 3/40

(52) U.S. Cl. CPC H02P 9/007; H02J 3/40; H02P 9/38

(57) ABSTRACT

An installation for generating a three-phase AC voltage to be fed into a power supply system, having a transformer connected to a three-phase generator on the output side to convert a first three-phase AC voltage into a second three-phase AC voltage having a second voltage level, which is lower than a first voltage level and a first frequency, and having a frequency converter connected to the transformer on the output side to supply a rotor winding with a third three-phase AC voltage to convert the second three-phase AC voltage into the third three-phase AC voltage having the second voltage level and a second frequency which is lower than the first frequency, wherein the frequency converter is designed such that the second frequency corresponds to a difference between a mains frequency of the power supply system and the first frequency.

### CROSS REFERENCE TO RELATED APPLICATIONS

This application is the US National Stage of International Application No. PCT/EP2017/059429 filed Apr. 20, 2017, and claims the benefit thereof. The International Application claims the benefit of European Application No. EP16170763 filed May 23, 2016. All of the applications are incorporated by reference herein in their entirety.

### FIELD OF INVENTION

The invention relates to an installation for generating a three-phase AC voltage to be fed into a power supply system, comprising at least one turbine and at least one three-phase generator driven by the turbine, wherein a generator rotor of the three-phase generator is coupled to a turbine rotor of the turbine for conjoint rotation.

Furthermore, the invention relates to a method for generating a three-phase AC voltage to be fed into a power supply system using at least one turbine and at least one three-phase generator driven by the turbine, wherein a generator rotor of the three-phase generator is coupled to a turbine rotor of the turbine for conjoint rotation.

### BACKGROUND OF INVENTION

Installations for generating a three-phase AC voltage and for supplying a power supply system with the three-phase AC voltage are sufficiently known and are used in power plants. Such an installation comprises at least one turbine, for example a gas turbine of a combined cycle power plant (CCPP) or of a gas turbine power plant or a steam turbine, and at least one three-phase generator, in particular turbogenerator, driven by the turbine.

A turbine rotor of the turbine is conventionally connected to a generator rotor of the three-phase generator rigidly or for conjoint rotation. In order to be able, by means of rotation of the turbine rotor, to generate a three-phase AC voltage having a customary power supply system frequency at a level of 50 Hz or 60 Hz using the three-phase generator and to feed it into the power supply system, the turbine rotor thus conventionally has to rotate at a frequency at the level of 50 Hz or 60 Hz, respectively.

Since the power and the efficiency of gas turbines having an operating frequency of 50 Hz (50 Hz gas turbines) are greater than for corresponding 60 Hz gas turbines, there is an interest in using 50 Hz gas turbines also to supply power supply systems having a power supply system frequency of 60 Hz (60 Hz power supply systems). By way of example, the power of the largest 50 Hz gas turbine, owing to the scaling approach in the design, is 44% greater than that of the largest 60 Hz gas turbine. Generally, in the case of 50 Hz gas turbines, owing to the lower rotational speed, it is possible to fix a power limit that is higher overall than in the case of 60 Hz gas turbines, since even with correspondingly longer turbine rotor blades, the centrifugal forces acting on the turbine rotor blades can be managed. The efficiency advantage of a 50 Hz gas turbine variant over a 60 Hz gas turbine variant is approximately 0.3% in the case of scaled gas turbines (i.e. one turbine variant was derived from a basic turbine variant by means of scaling factors), in particular by virtue of the lower clearance losses in the case of the 50 Hz gas turbine variant.

### SUMMARY OF INVENTION

One object of the invention is to enable the usability of turbines, in particular gas turbines, the operating frequency of which is lower than a power supply system frequency of a power supply system, to supply the power supply system with electrical energy. A further object of the invention is to improve frequency back-up operation of an installation for generating a three-phase AC voltage to be fed into a power supply system.

An installation according to the invention for generating a three-phase AC voltage to be fed into a power supply system comprises at least one turbine and at least one three-phase generator driven by the turbine, wherein a generator rotor of the three-phase generator is coupled to a turbine rotor of the turbine for conjoint rotation. According to the invention, the installation comprises at least one transformer which is electrically connected to the three-phase generator on the output side and by which a first three-phase AC voltage generated by the three-phase generator and having a first voltage level and a first frequency is able to be converted into a second three-phase AC voltage having a second voltage level, which is lower than the first voltage level, and the first frequency. Furthermore, the installation comprises at least one frequency converter which is electrically connected to the transformer on the output side and via which a rotor winding of the generator rotor is able to be supplied with a third three-phase AC voltage and by which the second three-phase AC voltage having the second voltage level and the first frequency is able to be converted into the third three-phase AC voltage having the second voltage level and a second frequency, which is lower than the first frequency. The frequency converter is designed or controllable and/or regulatable in such a way that the second frequency corresponds to a difference between a power supply system frequency of the power supply system and the first frequency.

If the rotational frequency of the turbine rotor, and thus of the generator rotor, is lower than the respective power supply system frequency of the power supply system to be supplied, the first frequency of the first three-phase AC voltage generated by the three-phase generator is lower than the power supply system frequency. In order nevertheless to be able to generate a three-phase AC voltage having the power supply system frequency using the three-phase generator, the rotor winding of the generator rotor, unlike conventional practice, is not supplied with a DC voltage, but rather with a three-phase AC voltage having the second frequency, wherein the second frequency corresponds to the respective difference between the power supply system frequency of the power supply system and the first frequency. As a result, a magnetic field rotating at the power supply system frequency is generated between the generator rotor and a generator stator of the three-phase generator. A stator winding of the generator stator thus sees a magnetic field rotating at the power supply system frequency, as a result of which a three-phase AC voltage having the power supply system frequency is induced in the stator winding.

Given a rotational frequency of the generator rotor for example at a level of 50 Hz, a magnetic field rotating at a rotational frequency at the level of 60 Hz, can be formed between the generator rotor and the generator stator by virtue of a suitable choice of the second frequency of the third three-phase AC voltage. This has the consequence that a three-phase AC voltage having a frequency at the level of 60 Hz is induced in the stator winding. As a result, at a machine transformer via which the three-phase generator is connected to the power supply system to be supplied, a 60 Hz three-phase AC voltage is present in order to be able to make the latter available to a 60 Hz power supply system with corresponding power. Consequently, with the installation according to the invention it is possible to feed a three-phase AC voltage having the power supply system frequency into the power supply system using a turbine whose turbine rotor rotational frequency is lower than the power supply system frequency of the power supply system. A higher specific power can be achieved as a result.

As a result of the supply of the rotor winding of the generator rotor with the third three-phase AC voltage having the second frequency, the stator winding of the generator stator can thus see a magnetic field rotating at the power supply system frequency. By virtue of a suitable choice of the second frequency, it is thereby possible to ensure frequency support by the installation according to the invention independently of the rotational frequency of the generator rotor. In particular, the installation according to the invention can offer frequency back-up in a very much wider frequency band than conventional installations. Moreover, the components of the installation according to the invention need not be designed in such a way that the components of the installation must be able to fulfil a specific frequency back-up band. Instead, the components can be designed for a specific operating point at which, in particular, the installation has a high efficiency and a high endurance. An installation having improved frequency back-up operation can thus be provided by means of the invention. By way of example, in the case of power supply system underfrequency, the connected turbines have to provide more power in order to be able to back up the power supply system frequency. As the rotational speed of the turbine rotor or of the generator rotor decreases, owing to the decreasing power supply system frequency, the power also decreases, however. This can be prevented with the installation according to the invention since the turbine can be decoupled from the power supply system frequency by way of the three-phase generator/frequency converter arrangement and in this respect can continue to provide its full power.

According to the invention, it is possible to compensate for deviations of the rotational frequency of the generator rotor or of the turbine rotor from the power supply system frequency of the power supply system by means of a supply of the rotor winding of the generator rotor with the third three-phase AC voltage having the second voltage level and the second frequency. As a result, a three-phase AC voltage having the power supply system frequency can be generated by means of the three-phase generator, even if the rotational frequency of the generator rotor differs from the power supply system frequency. Therefore, unlike conventional practice, it is not necessary to vary the rotational speed of the turbine rotor or of the generator rotor connected thereto for conjoint rotation in order to be able to adapt the frequency of the three-phase AC voltage generated by the three-phase generator to the power supply system frequency. Rather, the installation or its components, such as the turbine and the three-phase generator, for instance, can be designed for an optimum operating point and be kept at the operating point during the matching mentioned, which overall increases the efficiency of the installation.

According to the invention, by way of example, a 50 Hz gas turbine, the turbine rotor of which is connected to the generator rotor of a 50 Hz three-phase generator rigidly or for conjoint rotation, can be used for supplying a 60 Hz power supply system. The arrangement formed from the 50 Hz three-phase generator, the transformer and the frequency converter in this case can thus, according to the invention, be driven by a 50 Hz gas turbine and feed a three-phase AC voltage having a frequency at the level of 60 Hz into a 60 Hz power supply system.

The power and the efficiency of such an installation are considerably higher compared with a conventional 60 Hz gas turbine unit. Since, for example, the maximum power of the largest 50 Hz gas turbine is 44% greater than the maximum power of the largest 60 Hz gas turbine, it is possible to construct larger 60 Hz power plants with fewer blocks. By way of example, power plants which hitherto have been realized with three 60 Hz gas turbine/CCPP strings can be realized with two 50 Hz gas turbine/CCPP strings by virtue of the invention. As a result, an entire CCPP string consisting of gas turbine, generator, clutch, boiler, steam turbines and control system is omitted, which leads to an enormous cost saving. In the case of the 50 Hz turbines themselves, a corresponding reduction of the specific costs can also be observed since the 50 Hz turbine version is generally derived from the 60 Hz turbine version by scaling and in this case the costs rise far less than the power. This gives enough room to compensate for the additional costs caused in particular by the frequency converter.

The three-phase generator comprises a three-phase stator and a three-phase generator rotor. The three-phase stator is advantageously designed for the generation of a three-phase AC voltage having the power supply system frequency, for example 60 Hz, of a power supply system and is directly connected to the power supply system via a machine transformer. The three-phase stator can be embodied with a design that is customary for synchronous generators, comprising a laminated stator unit and a three-phase two-layer stator winding arranged thereon. The voltage of the stator winding can be of a magnitude that is customary for the respective application, for example 22 kV for a 60 Hz application.

The three-phase generator rotor is directly coupled to the turbine rotor of the turbine. The generator rotor can be embodied with a laminated rotor unit and a three-phase rotor winding arranged thereon. The three-phase rotor winding can be connected in star. The level of the second voltage can be approximately 5 kV. The three phases of the rotor winding are electrically connected to sliprings on a rotor shaft of the generator rotor. A three-phase brush system can run on the sliprings, which brush system can be constructed from a plurality of carbon brushes per phase and be mounted on a stationary brush apparatus. Via the brush system, the third three-phase voltage can be transmitted from the frequency converter via the stationary three-phase brush apparatus to the rotor winding of the rotating generator rotor.

The frequency converter can be electrically connected to the three-phase brush apparatus on the output side. As a result, the rotor winding can be supplied for example with a 5 kV/10 Hz three-phase system. The frequency converter can be constructed for example as a converter with a constant voltage intermediate circuit.

The installation according to the invention can also be utilized if the rotational speed of the turbine is intended to be chosen in a manner free from the customary power supply system frequencies at the level of 50 Hz and 60 Hz, in order thus to further increase the maximum power of the turbine. In particular, the installation according to the invention can be applied to turbines having arbitrary operating rotational speed and three-phase power supply systems having arbitrary power supply system frequency. This allows an optimum design of the turbine with regard to maximum power and maximum efficiency. Thus, by way of example, a 45 Hz gas turbine, the maximum power of which exceeds that of a 50 Hz gas turbine, by means of a corresponding increase in the second frequency in the output circuit of the frequency converter, can feed a 60 Hz three-phase AC voltage into a 60 Hz power supply system Likewise, a 45 Hz gas turbine with the installation according to the invention, given appropriate design of the components and suitable choice of the second frequency, can also feed a 50 Hz three-phase AC voltage into a 50 Hz power supply system.

According to the invention, it is possible to combine large gas turbines with a three-phase generator/transformer/frequency converter configuration that makes it possible to connect gas turbines having a rotational speed deviating from the power supply system frequency to a power supply system. With a three-phase generator according to the invention, it is possible to generate for example a 60 Hz three-phase system for drive with a 50 Hz gas turbine, as a result of which 50 Hz gas turbines can be applied to the 60 Hz market. The power and the efficiency of such a configuration are increased compared with a 60 Hz gas turbine unit.

From consideration of this situation regarding costs and efficiency, the possibility is afforded of fundamentally dispensing with the 60 Hz product line in the case of large gas but also steam turbines, since the 50 Hz product line can replace the 60 Hz product line owing to higher power, lower specific costs and improved efficiency. Furthermore, synergies arise during research and development and also in the supply chain (higher numbers, etc.), said synergies resulting in internal cost savings in the range of hundreds of millions of euros. This applies to turbines yet to be developed and equally to the existing portfolio. The latter should in this respect even be expected to benefit from the greater positive effects.

In an exemplary consideration of a 2+1 CCPP configuration in which two 5000 F gas turbines and one 60 Hz steam turbine each with their conventional air-cooled three-phase generators are replaced by two 4000 F gas turbines and one 50 Hz steam turbine each with the three-phase generator/transformer/frequency converter arrangement, the power increases by approximately 190 MW. The absolute package costs for the gas turbines, the steam turbine, the three-phase generators and component auxiliary systems remain the same, and that is already taking account of comparatively high frequency converter costs of approximately 50 €/kW. Furthermore, specific package costs fall by more than 25%. Moreover, the total installation efficiency (CCPP) rises by 0.6%, with the additional, conservatively determined, frequency converter losses of 0.2% already having been taken into account. Furthermore, the benefit regarding synergies during research and development and in the supply chain is greater for gas turbines having a reduced operating frequency by comparison with other frames originating from development, since these are mutually independently developed types of gas turbines which can scarcely profit from one another in this regard.

Advantageously, the installation comprises at least one three-phase capacitor bank connected in parallel with an output circuit of the frequency converter. The three-phase capacitor bank supplies a reactive power for the rotor winding. As a result, the electric current to be supplied by the frequency converter is reduced, as a result of which the structural size of the frequency converter can in turn be reduced. In particular, owing to the presence of the capacitor bank, it is possible not to conduct the entire power of the three-phase generator but rather only approximately 20% of this power via the frequency converter, which leads to a corresponding reduction of the frequency converter costs and to an improvement in the total efficiency of the arrangement formed from the three-phase generator and the frequency converter. The overall somewhat poorer efficiency of this arrangement by comparison with a simple three-phase generator can be more than compensated for by the improved efficiency of the driving turbine, in particular with a reduced operating frequency. The generator voltage can nevertheless be of a conventional order of magnitude.

The installation advantageously comprises at least one electronic control and/or regulation unit which is connected to the frequency converter in terms of communication technology and which is configured to detect an instantaneous difference between the power supply system frequency of the power supply system and the first frequency and to drive the frequency converter depending on the instantaneous difference. By means of the electronic control and/or regulation unit, the frequency converter can thus be controlled and/or regulated depending on the detected instantaneous difference between the power supply system frequency of the power supply system and the first frequency. The instantaneous power supply system frequency and the instantaneous first frequency can be detected by way of a sensor system and be fed to the electronic control and/or regulation unit for evaluation.

According to a method according to the invention for generating a three-phase AC voltage to be fed into a power supply system using at least one turbine and at least one three-phase generator driven by the turbine, wherein a generator rotor of the three-phase generator is coupled to a turbine rotor of the turbine for conjoint rotation, a rotor winding of the generator rotor is supplied with a three-phase AC voltage having a frequency corresponding to a difference between a power supply system frequency of the power supply system and a rotational frequency of the generator rotor.

The advantages mentioned above with regard to the installation are correspondingly associated with the method. In particular, it is possible to use the installation in accordance with one of its configurations or an arbitrary combination of at least two of these configurations with one another for carrying out the method. In this regard, advantageous configurations of the installation can be advantageous configurations of the method, even if this is not explicitly indicated hereinafter.

Advantageously, the three-phase AC voltage is generated by conversion of a three-phase AC voltage generated by the three-phase generator. This can be done using the transformer/frequency converter arrangement of the installation according to the invention, which is associated with the advantages mentioned above.

### BRIEF DESCRIPTION OF THE DRAWINGS

The invention is explained by way of example below on the basis of an embodiment with reference to the accompanying figure, wherein the features presented below, either in each case by themselves or in various combinations with one another, can constitute a developing or advantageous aspect of the invention. In the figure:

FIG. 1 shows a schematic illustration of one exemplary embodiment of an installation according to the invention.

### DETAILED DESCRIPTION OF INVENTION

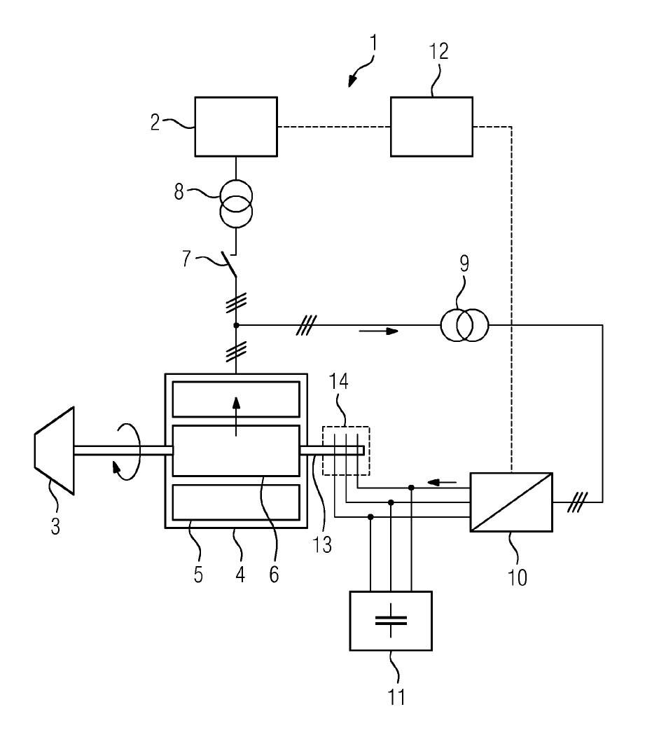

FIG. 1 shows a schematic illustration of one exemplary embodiment of an installation 1 according to the invention for generating a three-phase AC voltage to be fed into a power supply system 2.

The installation 1 comprises a turbine 3 in the form of a 50 Hz gas turbine, and a three-phase generator 4 driven by the turbine 3. The three-phase generator 4 comprises a three-phase stator 5 in the form of a 60 Hz three-phase stator and a generator rotor 6. The generator rotor 6 of the three-phase generator 4 is coupled to a turbine rotor (not shown) of the turbine 3 for conjoint rotation. The three-phase generator 4 is connected to the power supply system 2 via a disconnecting switch 7 and a machine transformer 8.

The installation 1 furthermore comprises a transformer 9 which is electrically connected to the three-phase generator 4 on the output side and by which a first three-phase AC voltage generated by the three-phase generator 4 and having a first voltage level and a first frequency is able to be converted into a second three-phase AC voltage having a second voltage level, which is lower than the first voltage level, and the first frequency.

Moreover, the installation 1 comprises a frequency converter 10 which is electrically connected to the transformer 9 on the output side and via which a rotor winding (not shown) of the generator rotor 6 is able to be supplied with a third three-phase AC voltage and by which the second three-phase AC voltage having the second voltage level and the first frequency is able to be converted into the third three-phase AC voltage having the second voltage level and a second frequency, which is lower than the first frequency. The frequency converter 10 is designed or controllable and/or regulatable in such a way that the second frequency corresponds to a difference between a power supply system frequency of the power supply system 2 and the first frequency.

The three phases of the rotor winding of the generator rotor 6 are electrically connected to sliprings (not shown) on a rotor shaft 13 of the generator rotor 6. A three-phase brush system (not shown) runs on the sliprings, said brush system being constructed from a plurality of carbon brushes (not shown) per phase and being mounted on a stationary brush apparatus 14. Via the brush system and via the stationary three-phase brush apparatus 14, the third three-phase voltage is transmitted from the frequency converter 10 to the rotor winding of the rotating generator rotor 6.

Furthermore, the installation 1 comprises a three-phase capacitor bank 11 connected in parallel with an output circuit (not shown) of the frequency converter 10.

Furthermore, the installation 1 comprises an electronic control and/or regulation unit 12 which is connected to the frequency converter 10 in terms of communication technology and which is configured to detect an instantaneous difference between the power supply system frequency of the power supply system 2 and the first frequency and to drive the frequency converter 10 depending on the instantaneous difference.

Although the invention has been more specifically illustrated and described in detail by means of the exemplary embodiment, nevertheless the invention is not restricted by the example disclosed and other variations can be derived therefrom by the person skilled in the art, without departing from the scope of protection of the invention.

1. An installation for generating a three-phase AC voltage to be fed into a power supply system, comprising:
at least one turbine and at least one three-phase generator driven by the turbine, wherein a generator rotor of the three-phase generator is coupled to a turbine rotor of the turbine for conjoint rotation,
at least one transformer which is electrically connected to the three-phase generator on the output side and by which a first three-phase AC voltage generated by the three-phase generator and having a first voltage level and a first frequency is able to be converted into a second three-phase AC voltage having a second voltage level, which is lower than the first voltage level, and the first frequency,
at least one frequency converter which is electrically connected to the transformer on the output side and via which a rotor winding of the generator rotor is able to be supplied with a third three-phase AC voltage and by which the second three-phase AC voltage having the second voltage level and the first frequency is able to be converted into the third three-phase AC voltage having the second voltage level and a second frequency, which is lower than the first frequency,
wherein the frequency converter is designed or controllable and/or regulatable in such a way that the second frequency corresponds to a difference between a power supply system frequency of the power supply system and the first frequency.

2. The installation as claimed in claim 1, further comprising:
at least one three-phase capacitor bank connected in parallel with an output circuit of the frequency converter.

3. The installation as claimed in claim 1, further comprising:
at least one electronic control and/or regulation unit which is connected to the frequency converter in terms of communication technology and which is configured to detect an instantaneous difference between the power supply system frequency of the power supply system and the first frequency and to drive the frequency converter depending on the instantaneous difference.

4. A method for generating a three-phase AC voltage to be fed into a power supply system using at least one turbine and at least one three-phase generator driven by the turbine, wherein a generator rotor of the three-phase generator is coupled to a turbine rotor of the turbine for conjoint rotation, the method comprising:
generating a first three-phase AC voltage by the three-phase generator which has a first voltage level and a first frequency which is converted into a second three-phase AC voltage having a second voltage level, which is lower than the first voltage level, and the first frequency by a transformer which is electrically connected to the three-phase generator on the output side,
supplying a rotor winding of the generator rotor with a third three-phase AC voltage by a frequency converter which is electrically connected to the transformer on the output side,
converting the second three-phase AC voltage having the second voltage level and the first frequency into the third three-phase AC voltage having the second voltage level and a second frequency, which is lower than the first frequency, by the frequency converter, and
generating the third three-phase AC voltage by the frequency converter in such a way that the second frequency corresponds to a difference between a power supply system frequency of the power supply system and a rotational frequency of the generator rotor.
